(19) United States
(12) Patent Application Publication
(10) Pub. No.: US 2016/0325657 A1
(43) Pub. Date: Nov. 10, 2016

(54) VENTILATION SYSTEM

(71) Applicant: GENTHERM AUTOMOTIVE SYSTEMS (CHINA) LTD., Langfang Hebei Prov. (CN)

(72) Inventors: Jonathan Zhang, Tianjin (CN); Felix Zhang, Langfang, Hebei (CN); Franky Shang, Langfang, Hebei (CN)

(73) Assignee: GENTHERM AUTOMOTIVE SYSTEMS (CHINA) LTD., Langfang Hebei Prov. (CN)

(21) Appl. No.: 15/108,639

(22) PCT Filed: Dec. 31, 2013
(86) PCT No.: PCT/CN2013/091052

§ 371 Date: Jun. 28, 2016

(51) Int. Cl. B60N 2/56; F25B 21/04

(52) U.S. Cl. CPC B60N 2/5692; F25B 21/04; B60N 2/5685; B60N 2/5657; F25B 2321/0252; F25B 2321/023

(57) ABSTRACT

Temperature conditioning device (10) for a temperature conditioned object (2), the temperature conditioning device (10) having at least one of the following components: a) a thermoelectric device (70) to heat or cool the temperature conditioned object (2), b) a fluid loop (42) to transport thermal energy within the temperature conditioned object (2), and c) a ventilation device (57) to generate an air stream (59) to exchange thermal energy with the surrounding.

### FIELD OF THE INVENTION

One subject in accordance with the invention at hand is a ventilation system in accordance with the generic term of Claim 1. The system may be used, for example, for temperature control of beverages, seat surfaces or for the heating of armrests, particularly in vehicles.

### BACKGROUND OF THE INVENTION

For the ventilation of seat surfaces, it has been known, for example from DE 197 36 951, to arrange a space fabric on the surface of the seat and to guide a flow of air through it.

From DE 195 27 352 C2 it has been known to design the foam padding of a seat in the shape of nubs.

Some applications require alternative or improved options that are advantageous with regard to their manufacturing costs, to their ability to create a pleasant climate, to an efficient distribution of thermal energy and/or to their energy consumption.

### SUMMARY OF THE INVENTION

To improve the prior art, a technical concept with the characteristics of claim 1 is being proposed. Additional advantageous embodiments can be gleaned from the additional claims and the subsequent description.

### BRIEF DESCRIPTION OF THE DRAWINGS

In the following, details of the invention will be explained. These statements should make the invention comprehensible. However, they have only exemplary character. Of course, individual or several characteristics as described may be omitted, modified or supplemented within the framework of the invention defined by independent claims. Also, the characteristics of various embodiments may be combined with each other. The decisive factor is that the concept of the invention be essentially implemented. If one characteristic can be partially fulfilled, this will include that this characteristic is fulfilled completely as well, or is essentially completely fulfilled. “Essentially” shall denote in this context in particular that the implementation permits obtaining the desired benefit to a recognizable extent. This may mean in particular that a corresponding characteristic is met at least at 50%, 90%, 95% or 99%. If a minimum amount is indicated, it will of course be possible to use more than such a minimum amount. If the number of a component is indicated with at least one, this shall also include embodiments with two, three or any other multitude of components. What is described for one object may also be applied to the overwhelming part or totality of all other objects of the same type. Unless stated to the contrary, intervals shall include their boundary points.

In the following, reference will be made to:

FIG. 1 Vehicle 1 with a seat as temperature conditioned object 2 in a partial longitudinal cut

FIG. 2 Perspective view of a temperature conditioning device 10 for the temperature conditioned object 2 of FIG. 1

FIG. 3 Exploded view of a temperature control device 20 of a temperature conditioning device 10 of FIG. 2

FIG. 4 Alternative embodiment of a temperature control device 20′ of a temperature conditioning device 10 of FIG. 2

FIG. 5 Plane view of an alternative heat exchange pad 35′

### DETAILED DESCRIPTION

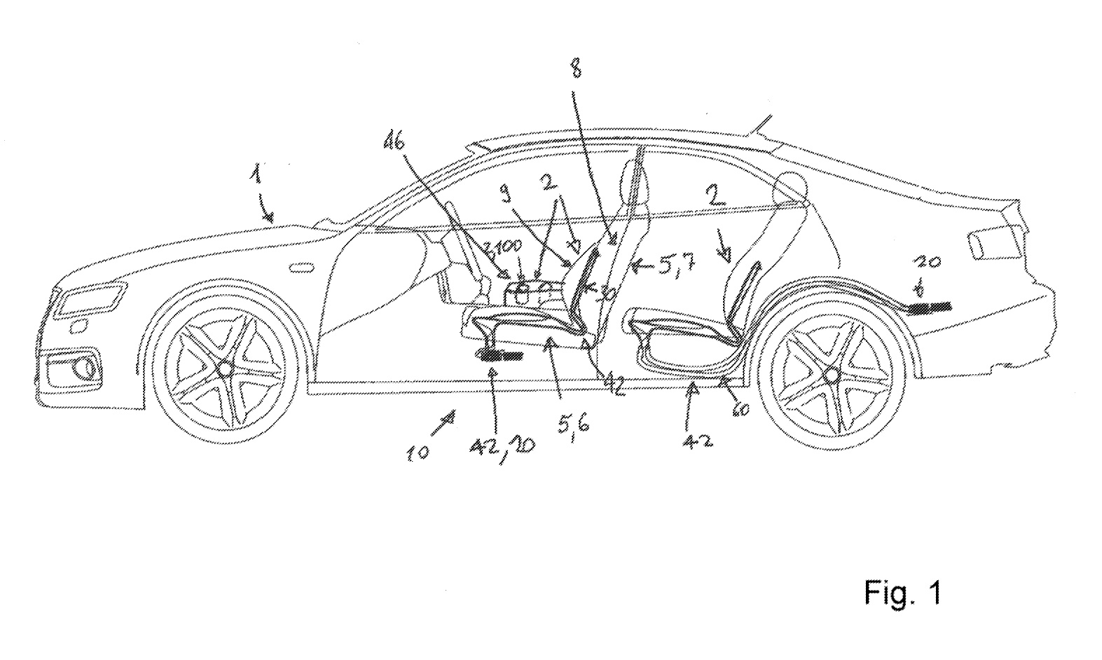

The invention is particularly well suited for use in a vehicle 1 as in FIG. 1. This denotes in particular all land, water or aircraft such as, for example, an airplane, a rail vehicle, a ship or a motor vehicle.

The invention is moreover suited for use in all objects, whose surface is to be conditioned at least partially in such a way that at least certain climatic parameters, for example temperature or humidity, are kept at a desired interval or at a certain value at least close to the surface. Beds in vehicles, in tents or in houses are one field of possible use. Therefore, “temperature conditioned object” denotes in particular all components with which a user may come in contact, especially in a passenger compartment of a vehicle 1, such as a steering mechanism for a vehicle, a dashboard, an armrest, a door paneling, a seat cover, a seat or a cup holder. It may be useful for at least one vehicle to have at least one temperature conditioned object 2, such as, for example, a seat. This permits a pleasant climate of a passenger even during long trips under extreme conditions.

FIG. 1 shows a vehicle seat 5 with a seat part 6 and a backrest 7. In the exemplary embodiment these are covered with a non-perforated leather cover. The seat part has a contact surface, which is usually occupied by a passenger when the seat is in use.

It may be useful for at least one temperature conditioned object 2 to have at least one padding 5, such as a block of foam polyurethane.

It may be useful for at least one temperature conditioned object to have at least one cover 9. This denotes any kind of surface covering the padding, for example textile covers or an external skin of a padding foam. But the invention is especially suitable to improve the comfort of leather surfaces.

It may be useful for at least one temperature conditioned object 2 to have at least one temperature conditioning device 10. This denotes all devices that serve to regulate one or more climate parameters, like temperature, humidity and air movement in an area to be conditioned, for example surfaces touched by the user(s) in the passenger compartment of a vehicle 1.

It may be useful for at least one temperature conditioning device 10 to have at least one

It may be useful for at least one temperature control device 20 to have at least one thermoelectric device. A thermoelectric device shall especially mean a solid-state active heat pump. It usually is a flat part, which under consumption of electrical energy transfers heat from its one side to its other side.

This creates an electrically cooled side 71 and an electrically heated side 72 of the thermoelectric device 70. The thermoelectric device 70 can be supplied with one or more Seebeck elements.

At least one temperature control device 20 is provided with at least one thermal recharge device 73. Such a thermal recharge device 73 ensures a sufficient heat supply. That could be from a heated side 72 of the thermoelectric device 70 to the temperature conditioned object 2. But here it is from the temperature conditioned object 2 to the cooled side 71 of the thermoelectric device 70.

The thermal recharge device 73 is preferably provided with a plate or formed like a plate, which is at least partly made of a heat conducting material like copper or aluminum. In addition or alternatively it can at least partly be made of a heat storing material, like ceramic or water. This allows a use of the thermal recharge device 73 as an intermediate storage. This makes the temperature supply more uniformly.

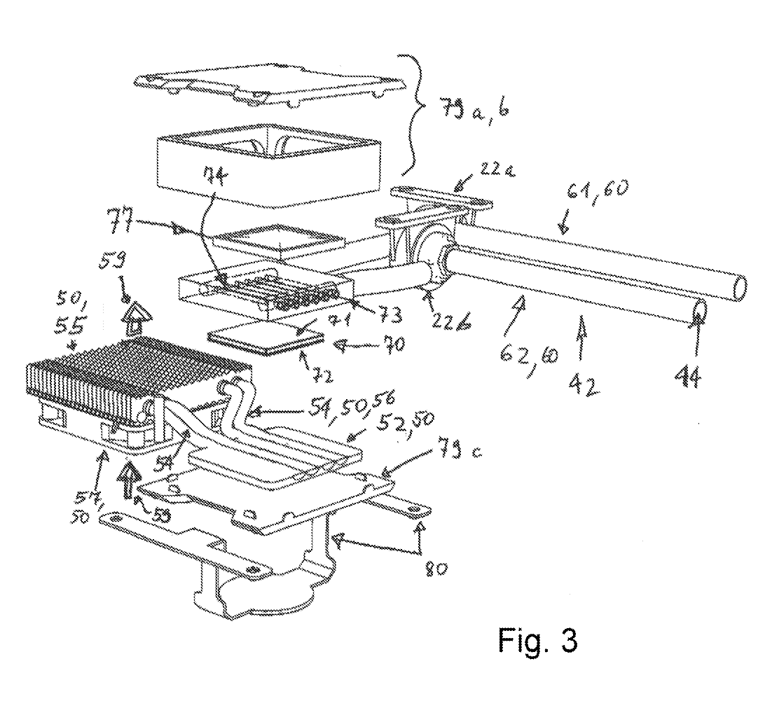

In the embodiment shown in FIG. 3, at least one thermal recharge device 73 is arranged in thermal contact with the cooled side 71 of the thermoelectric device 70. Preferably the thermal recharge device 73 covers at least a part of the cooled side 71, preferably an essential part.

The temperature control device 20 allows a fluid 44 to pass through it or along its surface. Therefor it is provided with one or more hollow spaces 74. Such a hollow space can be formed e.g. like a) the inner volume of a tank, b) a meandering channel or c) a multitude of channels running in parallel, side-by-side or interwoven with each other.

At least one temperature control device 20 is preferably provided with a heat removal device 50. This allows a removal of thermal energy from a thermoelectric device 70 and/or a thermal recharge device 73.

For this purpose the heat removal device 50 is provided with at least one heat absorber 52. “Heat absorber” shall mean a device for efficient heat transfer from one medium to another. In this application it absorbs the heat of the heated side 72 of the thermoelectric device 70 and guides it into tips of one or more heating pipes 52. To efficiently provide that, the heat absorber 52 is shaped like a plate, preferably of similar size like the thermoelectric device 70 or thermal recharge device 73. Its thickness is large enough to embed at least one pipe at least partly. But to save material it could also be shaped like a thin plate and bend at least partly around a heat pipe with its ends in parallel to the thermoelectric device 70. This thin plate could be put simply on the heated side of the thermoelectric device 70, sandwiching the heat pipe between the plate and the thermoelectric device 70. Preferred materials include metal, like aluminum, and any other thermally conductive material.

A heat removal device 50 preferably is provided with a heat transmitter 54 this could be a heat sink with metal fins. But it is preferred to use one or more heat pipes. A heat pipe is a heat-transfer device having a heat absorbing and a heat discharging interface. At the heat absorber 52 a first liquid fluid 88 withing the heat pipe turns into vapor, thereby absorbing heat. The vapor is guided within the heat pipe 54 to a heat discharger 55. As the heat discharger 55 is cooled from outside, the vapor condenses back into a liquid—releasing the heat. The liquid then returns to the heat absorber e.g. by capillary action. The heat pipes are preferably tubes of copper or aluminum.

“Heat discharger” includes any heat exchange device, which efficiently transfers heat from the heat transmitter to an external air stream. “External” means an air stream from and/or to the surrounding of temperature conditioned object 2. That air stream could be used to supply thermal energy, but in this application it is used to remove waste heat.

The heat discharger 55 could be and kind of heat exchanger. In this application it is provided by grille of a multitude of metal plates, which conduct heat from the heat pipes into an airstream 59. The heat discharger 55, namely the grille, is a block having a plane of extension.

The heat absorber 52, the heat discharger 55 and the heat transmitters 54 thereby form a heat removal loop 56, which is much more efficient for temperature conditioning the thermoelectric device 70 than typical heat sinks, especially for cooling the heated side 72. Nevertheless is required due to cost or available space, the heat removal loop 56 could be replaced by a heat absorber made of a metal plate with heat fins, e.g. of aluminum.

It may be useful for at least one heat removal device 50 to have at least one ventilation device 57. This denotes any device that can be used for a change of air in a specific area, for example, an on-board air conditioner or axial or radial ventilators. Some applications require two ventilation devices 57 per temperature conditioned object 2 or per temperature conditioned surface.

In a preferred embodiment the ventilator is a flat axial ventilator, combined with the heat discharger 57 as a preassembled module. The ventilator preferably has a thickness of less than 2 centimeters, preferably less than 15 mm. This leads to a very flat unit, which can be put under any vehicle seat.

The air stream 59 of at least one ventilation device 57 is preferably perpendicularly directed to a plane of a heat discharger or its grille.

The air stream 59 of at least one ventilation device 57 can be directed in parallel to a plane of a thermoelectric device 70. But in the embodiment of FIG. 3 the air stream 59 of at least one ventilation device 57 is preferably perpendicularly directed to a plane of a thermoelectric device 70. But the ventilation device 57 has a turbine with an axis of rotation, which does not penetrate the thermoelectric device 70, but is shifted sideways. This improved the heat removal, as the direction of the air stream is unchanged after passing the heat discharger 55.

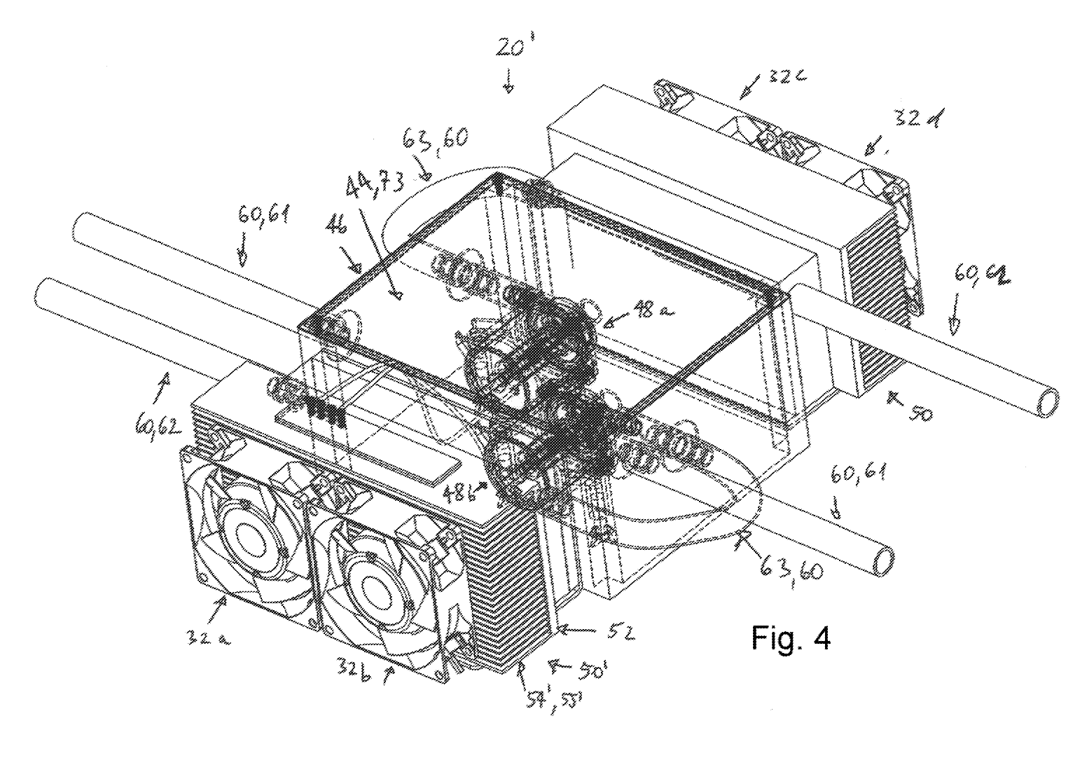

It may be useful for at least one temperature control device 20 to have at least one additional heating device 77. Such an additional heating device 77 can be or be provided e.g. with a printed plastic film heater, a ceramic PTC heater, metalized ceramic heater or a resistance wire. It may have the shape of a pipe, a chip or a Litz wire. The heater is preferably provided at or in contact with the thermal recharge device 73 at an area distant to its contact area with the thermoelectric device 70. In one preferred embodiment (FIG. 3), the additional heating device 77, the thermal recharge device 73 and the thermoelectric device 70 form a sandwich with the thermal recharge device 73 in the middle. In another preferred embodiment (FIG. 4), the additional heating device 77 is arranged within the thermal recharge device 73. Both allows efficient heating and cooling.

Preferably the temperature conditioning device 10 contains at least one user-sided heat exchange device 30. This shall refer to any device, which allows a heat exchange between a user and the temperature conditioning device 10.

At least one user-sided heat exchange device 30 is arranged at least partially close to a surface to be temperature controlled, e.g. between a padding 5 and a surface to be temperature controlled, preferably between a seat foam padding 8 and a seat cover 9, especially on an A-side facing a user. Preferably, at least one user-sided heat exchange device 30 extends essentially parallel to the surface to be temperature controlled.

In its most simple form the user-sided heat exchange device 30 is one or a multitude of tubes, which run along the surface in a wave-like or intermeshed pattern. Preferably such tubes are stabilized by one or more carriers of textile of film. This allows forming a heat exchange pad 35. This flat component can simplify the handling of the tubes.

Preferably, at least one heat exchange pad 35 is flat, flexible and hollow. Further, it is pressure resistant enough to ensure proper operation, even when loaded with the weight of a passenger. This ensures that fluid is guided in at least one direction along its plane, preferably in at least two directions over the surface to be temperature controlled.

Preferably a heat exchange pad 35 is provided with at least one layer to form at least one channel. Preferably a heat exchange pad 35 has at least two layers, which cover each other and are attached or sealed to each other, e.g. by RF welding. The two or more layers can be stuck or welded to form one or more channels. The pad or layer may be at least partly made of plastic, rubber, PP, PE, silicone, polyurethane, TPU compound cloth, plastic film or compounds of those materials.

One heat exchange pad 35 can be enough to control the temperature of a temperature conditioned object 2. But for some applications, it might be better to have a multitude of heat exchange pads 35 for one temperature conditioned object 2. This might be required to follow the contour of the temperature conditioned object 2 or to bridge a trench in the surface of a seat. Therefor a seat can be provided with at least one heat exchange pad 35A for the central cushion part and two heat exchange pads 35 B, C for the two side parts. Further three heat exchange pads 35 D, E, F can be provided in a backrest.

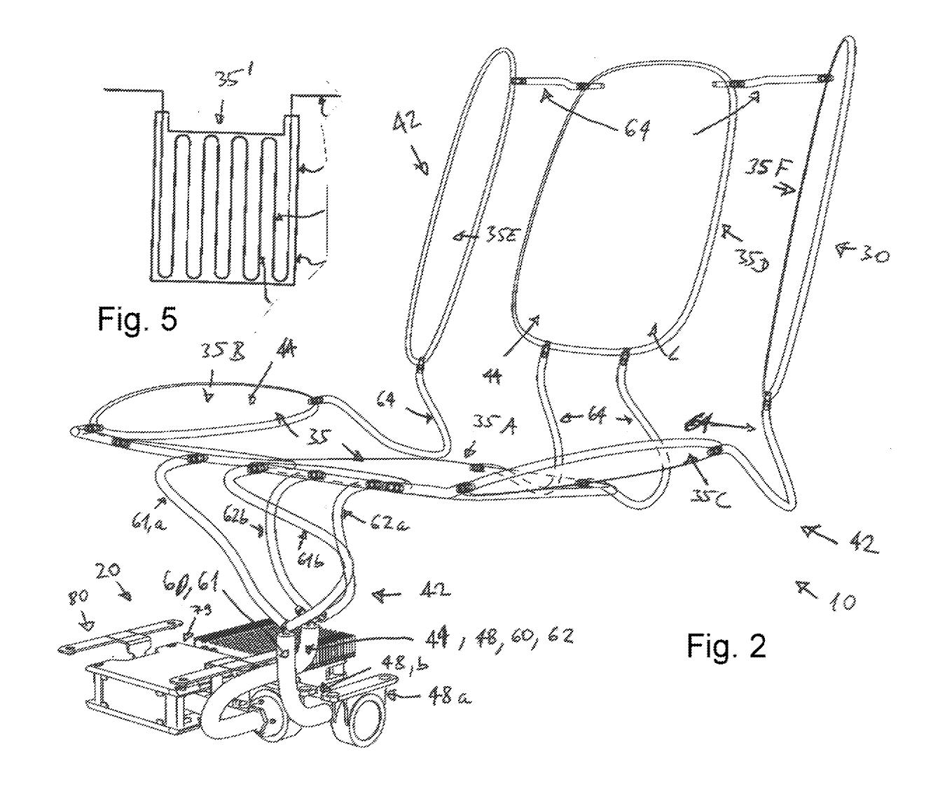

It may be useful for at least one temperature conditioning device 10 to have at least one fluid loop 42 in accordance with FIGS. 1 and 2. Its purpose is to transport thermal energy within the temperature conditioned object 2. The fluid loop is preferably a sealed system, from or to which during normal operation neither fluid is taken nor supplied.

Preferably the fluid loop 42 contains a second fluid 44, which differs from the fluid 88 within the heat pipe 54. The fluid 44 is preferably a liquid for absorbing and carrying thermal energy. It could be chemically the same or a similar substance like the fluid 88. It should be safe for the user, even if it escapes through a leakage. In addition, it should not solidify, even at low temperatures. So its freezing point is preferably below −20° C., or better below −40° C. Good examples are pure water, medical glycerin (preferably 50-70%), glycol, medical alcohol, oil, salt solutions or mixtures thereof. The high thermal capacity of such materials favors the efficiency of the heat exchange.

Preferably the fluid loop 42 contains a fluid tank 46. The fluid tank 46 preferably serves as an additional or alternative thermal recharge device 73. That makes it easier to keep the fluid 44 within the fluid loop 42 at a stabile temperature. For that purpose, the volume of the tank has preferably at least one quarter of the volume of the fluid loop 42, preferably one third.

The walls of the fluid tank 46 can be made of plastic or another material suitable to safely keep liquid over the lifetime of the vehicle. Preferably they are made at least partly of aluminum or another metal, to allow an easy transfer of heat through an area, where a heat pump is located. This allows a use of the tank 46 directly as a heat sink of one side of a TED.

For some applications it might be of advantage to provide one or more (not shown) further heating elements in addition or as an alternative to the additional heating element 77 at or within the fluid tank 44. That would allow heating the fluid 44 quicker.

The tank system can be placed in different location in car. Preferably it is put in a zone, where its temperature is not influenced by sun beams. A good position would be e.g. between two front seats or two back seats, at the floor of the vehicle, in a trunk or under a seat, especially that of a cushion of a back seat.

But to reducing the size of the system and the necessary liquid quantity, the fluid tank could be eliminated. A thermal recharge device 73 of a metal plate with channels would be enough.

It may be useful for at least one climate control device 10 to have at least one fluid moving device 48. This denotes any device that is suitable to move fluid within the fluid loop 42, in particular a rotary or piston pump.

The fluid moving device can be placed under or within a seat cushion to increase efficiency or within a trunk to reduce noise. But it can also be selected as an under liquid pump to be placed within a fluid tank 46 to make the system more compact and to reduce vibration.

The fluid moving device is selected to have enough pressure to keep the liquid channel open when occupant sitting on the bag. Preferably the pump pressure is e.g. about 1-10 m lift head, preferably 1-3 m.

One fluid moving device 48 can be sufficient to supply the whole vehicle cab. But it is preferred to supply each temperature conditioned object with its own fluid moving device 48a,b.

A fluid loop 42 is preferably at least partly built of one or more fluid conductors, e.g. pipes or tubes. Such a fluid conductor 60 is preferable at least partly made of an elastic but tear-resistant and pressure-resistant material. That can be one or more of these components: rubber, polyurethane (especially resistant to hydrolysis), silicone, latex, PVC or a gel of synthetic material like polyurethane gel. The material should have an elongation rupture of at least 100%. Alternatively or additionally, a fluid conductor can be made at least partially of a textile material, for example of a weave, fabric, knit or mesh. This will permit high flexibility with low weight. The fluid conductor 60 can have an outer cross-sectional diameter of e.g. between 3 and 10 mm, especially for areas, where much heat shall transfer through the walls of the fluid conductor 60, while the fluid is transported through the fluid conductor 60. The fluid conductor 60 can have an outer cross-sectional diameter of e.g. between 26 and 36 mm, especially for sections, where the fluid 44 shall pass through the fluid conductor 60 with a minimum heat transfer via the walls of the fluid conductor 60.

At least one fluid conductor 60 serves as a supply tube 61 to supply at least one heat exchange pad 35 with thermally conditioned fluid 44. In summer this fluid is cooled by the thermoelectric device 70. In winter it is heated by the additional heating device 77. Both takes place within the thermal recharge device 73. At least one supply tube 61 is connected with one or more heat exchange pads 35. Especially big heat exchange pads 35 are better supplied with a multitude of supply tubes 61. It is possible to connect each heat exchange pad 35 with its own supply tube 61. But in a preferred embodiment the heat exchange pads 35A of a central seat cushion are the only pads connected with a supply tube 61. This concentrates the available thermal energy onto the surface, which has the biggest common surface and most intensive contact of a seat 5 with a passenger.

At least one fluid conductor 60 serves as an exhaust tub 62 to remove thermally exhausted fluid from at least one heat exchange pad 35. It is redirected into the thermal recharge device 73. Therefore at least one exhaust tube 61 is connected with one or more heat exchange pads 35. Especially big heat exchange pads 35 are better connected with a multitude of exhaust tubes 62. It is possible to connect each heat exchange pad 35 with its own exhaust tube 62. But in a preferred embodiment the heat exchange pads 35 B, C of side seat cushions are the only pads connected with an exhaust tube 61. This allows a use of thermally nearly exhausted fluid for side zones of minor importance.

For some applications, it can be helpful to connect the thermal recharge device 73 with the fluid tank 46 via one or more recharge tubes 63. This allows a reduction of nominal power of the temperature control device 20, e.g. to 100-120 W, while still having a good thermal supply with a pre-conditioned quantum of fluid of the fluid tank 46.

At least one fluid conductor 60 serves as a connection tub 64 to connected one or more heat exchange pads 35 with each other. It is possible to connect all heat exchange pads 35 in serial, so that the fluid passes one after the other. It is also possible to connect all heat exchange pads 35, while they are arranged in parallel (from a fluid perspective). This creates one or more bypasses, in case a heat exchange pad 35 or its respective supply or exhaust tube is blocked.

In a preferred embodiment the heat exchange pads 35 B, C of side seat cushions are connect in serial with respective heat exchange pads 35 E, F of side backrest cushions. The heat exchange pad 35 A of central seat cushion is connect in serial with a respective heat exchange pad 35 D of a central backrest cushion. Further, the heat exchange pads 35 B, C, E, F of the side backrest cushions are in serial with the heat exchange pads 35 A,D of the central backrest and cushion. This allows that the thermal effect is primarily directed to the most important parts, first the central cushion, than the central backrest.

In a preferred embodiment the heat exchange pads of a first seat are connected in parallel with the heat exchange pads of a second seat.

It may be useful for at least one temperature control device 20 to have at least one insulating housing 79. If this is divided into a upper cover 79a, a frame 79b and a lower cover 79c, this simplifies assembly and saves energy.

by means of a supporting structure 80 the temperature control device 20 can be easily fixed under seats, under an armrest or at the backrest of a seat.

FIG. 1 shows a vehicle having a cup holder 100 as a temperature conditioned object 2. A cup holder 100 is a device to hold a cup or other drinking vessel. It can have a movable or rigid holding device and an opening to insert the cup. Preferably the cup holder 100 has at least one surface, which is temperature controlled. This can be achieved by installing one or more heat exchange pads 35 at, around or within the holding device, the opening or the bottom of the cup holder 100.

It can also be of advantage to have one or more cup holders directly or indirectly thermally connected to one side of the thermoelectric device 70 or to the fluid tank 44. In a preferred embodiment the cup holder 100 is embedded, in thermal contact or a part of the fluid tank 44. It is especially preferred if the wall of the fluid tank 44 is at least partly identical or in thermally conductive contact with the wall of the cup holder 100.

One or more further cup holders could be directly or indirectly thermally connected to the other side of the thermoelectric device 70 and/or the air stream 59.

In a not shown vehicle, cabin or building the invention could be used to control the temperature of a bed, a cover sheet or a mattress. For that purpose one or a multitude of heat exchange pads 35 are arranged in one or more of these subjects. Preferably a heat exchange pad 35 in an area of a head of a user is provided with cooled. Additionally or alternatively an area of feet of a user is warmed. A simultaneous combination is be possible, e.g. if at least one heat exchange pad 35 is warmed in the waste air stream of the heat removal device or if the waste air is directed to the feet of the user.

Any application described above can also be used for heating purpose just by changing the operation direction of the heat pipes, by inverting the circulation direction of the fluid 44 and/or by switching the polarity of the thermoelectric device 70.

A temperature conditioning device 10 can have at least one fluid loop 42, coupled to a first side of a thermoelectric device 70 to transport thermal energy within the temperature conditioned object 2. In addition thereto the temperature conditioning device 10 has a heat removal loop 56, which is coupled to a second side of a thermoelectric device 70. This allows temperature conditioning of the thermoelectric device 70.

| | |
|---|---|
| 1 | vehicle |
| 2 | temperature conditioned object |
| 5 | Seat |
| 6 | seat part |
| 7 | backrest |
| 8 | padding |
| 9 | cover |
| 10 | temperature conditioning device |
| 20 | temperature control device |
| 30 | user-sided heat exchange |
| | device |
| 35 | heat exchange pad |
| 42 | fluid loop |
| 44 | fluid |
| 46 | fluid tank |
| 48 | fluid moving device |
| 50 | heat removal device |
| 52 | heat absorber |
| 54 | Heat transmitter |
| 55 | heat discharger |
| 56 | heat removal loop |
| 57 | Ventilation device |
| 77 | additional heating device |
| 60 | fluid conductor |
| 61 | Supply tube |
| 62 | exhaust tub |
| 63 | recharge tube |
| 64 | connection tube |
| 70 | thermoelectric device |
| 71 | cooled side |
| 72 | heated side |
| 73 | thermal recharge device |
| 74 | hollow space |
| 79 | insulating housing |
| 80 | supporting structure |
| 100 | cup holder |

1. A temperature conditioning device for a temperature conditioned object, the temperature conditioning device having at least one of the following components:
a) a thermoelectric device to heat or cool the temperature conditioned object,
b) a fluid loop to transport thermal energy within the temperature conditioned object, and
c) a ventilation device to generate an air stream to exchange thermal energy with the surrounding.

2. The temperature conditioning device according to claim 1, the temperature conditioning device having a fluid loop containing a fluid having a freezing point below −20° C.

3. The temperature conditioning device according to claim 1, wherein the temperature conditioning device includes:
at least one fluid loop coupled to a first side of a thermoelectric device to transport thermal energy within the temperature conditioned object, and
in addition thereto a heat removal loop coupled to a second side of a thermoelectric device for temperature conditioning the thermoelectric device.

4. The temperature conditioning device according to claim 1, wherein the temperature conditioning device includes:
a heat discharger having a plane of extension;
a ventilation device generating an airstream perpendicular to the plane of extension and passing through a heat discharger, and
a direction of the airstream before entering the heat discharger is a same direction as behind the heat discharger.

5. A temperature conditioned object, provided with at least one temperature conditioning device in accordance with claim 1, the temperature conditioned object being at least one of the following elements: a seat, a bed, a cup holder.

6. A vehicle comprising: at least one device in accordance with claim 1.

7. The temperature conditioning device according claim 2, wherein the temperature conditioning device includes:
at least one fluid loop coupled to a first side of a thermoelectric device to transport thermal energy within the temperature conditioned object, and
in addition thereto a heat removal loop coupled to a second side of a thermoelectric device for temperature conditioning the thermoelectric device.

8. The temperature conditioning device according to claim 3, wherein the temperature conditioning device includes:
a heat discharger having a plane of extension;
a ventilation device generating an airstream perpendicular to the plane of extension and passing through a heat discharger, and
a direction of the airstream before entering the heat discharger is a same direction as behind the heat discharger.

9. The temperature conditioning device according to claim 7, wherein the temperature conditioning device includes:
a heat discharger having a plane of extension;
a ventilation device generating an airstream perpendicular to the plane of extension and passing through a heat discharger, and
a direction of the airstream before entering the heat discharger is a same direction as behind the heat discharger.

10. A temperature conditioned object, provided with at least one temperature conditioning device in accordance with claim 9, the temperature conditioned object being at least one of the following elements: a seat, a bed, a cup holder.
